(19) United States
(12) Patent Application Publication
(10) Pub. No.: US 2016/0034521 A1
(43) Pub. Date: Feb. 4, 2016

(54) METHOD, DEVICE AND SYSTEM FOR RETRIEVING DATA FROM A VERY LARGE DATA STORE

(71) Applicant: BLUECAT NETWORKS, INC., Toronto (CA)

(72) Inventors: John E. Lumby, Toronto (CA); Steven P. Meyer, Richmond Hill (CA)

(21) Appl. No.: 14/813,041

(22) Filed: Jul. 29, 2015

Related U.S. Application Data
(60) Provisional application No. 62/030,534, filed on Jul. 29, 2014.

(51) Int. Cl. G06F 17/30

(52) U.S. Cl. CPC G06F 17/30371; G06F 17/30348; G06F 17/30395; G06F 17/30463

(57) ABSTRACT

Systems, methods and devices are provided for deploying data from an operational database with multi-version-concurrency-control, the method comprising: deriving a single SQL query statement for retrieving large amounts of related, heterogeneous data as output where the large amounts of data are internally self-consistent; transforming and decorating the single SQL query output to obtain deployment data; and transferring the deployment data to the deployment target.

### CROSS-REFERENCE TO RELATED APPLICATIONS

This application claims priority to U.S. Provisional Application, No. 62/030,534, entitled “Method, Device and System for retrieving data from a very large data store” filed Jul. 29, 2014, which application is hereby incorporated in its entirety by reference.

### FIELD

This invention relates generally to the subject of retrieving data from large computer databases.

### BACKGROUND

Many data processing systems include tasks to extract large quantities of information from an operational datastore and then deploy the extracted information to an external and independently operating machine or system by means of a variety of network protocols. There can also be intermediate steps where extracted information undergoes one or more transformations.

In many cases the datastore where deployment data is gathered from may undergo updates during a deployment process. However, this can cause complications where a consistent view of the complete operational datastore data must be deployed in order to maintain relationships between items of data.

As an example, a factory which maintains operational information on customer orders, parts and sub-assemblies; production facilities; and builds a shop floor schedule periodically describing tasks to be completed for individual facilities and required parts for each facility may then deploy this to the factory production system.

As another example, the process by which dynamic Internet Protocol (IP) data managed by an IP Address Manager (IPAM) is deployed to a Dynamic Host Configuration Protocol (DHCP) server is called an IP network deployment. For instance, a DHCP server may run software that is provided by the Internet Systems Consortium (ISC). The IPAM can store dynamic IP data in categories such as networks and DHCP pools. This data can be frequently updated by network administrators and can also be deployed to DHCP servers in order for users to obtain leases of IP addresses.

Based on the deployment target information, data objects required for deployment can be extracted from a data store. In the factory example these objects can include customer orders, parts and machine tools. In the network example these can include networks and their DHCP pools, static IP addresses and DHCP options.

Next the data objects can be organized into groupings for analysis. These groupings can broadly correspond to the external system organization as determined by pre-existing topological and functional configurations of the external system. For example, groupings can be machine tools or networks for the provided examples. Information related to the topological and functional configurations of the external system can be obtained by analyzing a design and operation of the external system to determine the configuration and data sets required for a deployment. Each grouping can be transformed using the target information into part of a document or a set of activities which expresses the intent of the deployment. This expression can occur in a language according to a required output specification of a receiving agent. The intent typically describes the deployment in terms which are meaningful to the deployment target external system. This can be similar to a computer programming language with procedural semantics or can merely be descriptive, such as an XML file. The document or set of activities can be the combined set of all transformed groupings. The required output specification can describe the content, syntax and order of items within the document or set of activities. It can also unambiguously describe the nature of the document's required contents. A particular output specification need not state a list of numbers and words for a specific deployment since the list of numbers and words can change from one deployment to another. However, the output specification can include rules and requirements to produce numbers and words for specific deployments.

The document or set of activities can be transmitted to a receiving agent that can process the document or perform the activities, including optionally updating a service running on a target external machine or system. As an example, a supervisor program executing on at least one machine acting as a receiving agent can update a target external machine or system configuration including all associated data based on received, updated information and restart the target external machine or system configuration using the received, updated information. The document or set of activities can be consistent from one iteration to another. For example, day-to-day updates for a single deployment target can appear similar for a single deployment target. However, documents or sets of activities for different deployment targets can be highly diverse or distinct.

Building a deployment task can be difficult in dynamic environments where data is constantly being updated. Since the data is constantly being updated, extracting required data from an operational datastore in an efficient manner can be difficult. Consistency of values of the returned set of data (i.e. internal self-consistency) is a property of the values such that these values all existed in the database at a single point in time. Consistency is essential to solve this problem. Numerous methods have been developed to address this problem, each suffering from disadvantages.

As early as the early 1970's, a deployment task was accomplished by scheduling a job to run on its own at a time when regular users were not using the system. For example, a weekly payroll process could be a job. Thus, the job could run with exclusive use of an associated system and datastore including most or all associated resources. The time period when this could occur was referred to as a batch window and usually extended from the end of working hours on one day until the start of working hours on the next day, a fairly long period of time. However, many companies now operate globally and have employees working around the clock, running ever increasing numbers of jobs. Thus, the traditional batch window is no longer a viable option.

Since at least the 1980's, datastores with concurrency controls such as relational databases have made it possible to run jobs against an operational datastore while users are updating the datastore. This process has issues as well, including costs such as delays to jobs and users caused by serialization and locking mechanisms that are employed to ensure integrity and consistency in the system.

One method of ensuring internal self-consistency while reducing locking of data records for the exclusive use of one process is to copy or “snapshot” relevant tables of the operational datastore in a separate set of tables. Operations and calculations can then be performed using the copy while the original datastore continues to be updated. Unfortunately, with the increasing size of operational datastores, snapshots impose an excessive overhead that can result in significant system delays. Additionally, if multiple deployment jobs are scheduled to run at times which overlap, individual snapshots may be required for each job or temporary serialization for jobs using a single snapshot will be required. Thus, each deployment job may need to finish with a previous snapshot before proceeding to a current snapshot.

Advanced relational databases can provide consistency when reading a production operational datastore by mimicking the effects of a snapshot without the overhead required to actually take a snapshot. In an example embodiment, PostgreSQL [POSTGRESQL] can provide a “read committed” isolation level. In effect, a database query using Structured Query language (SQL) can “see” a snapshot of the production operational datastore as of an instant the query begins processing. However, “read committed” applies to a single SQL statement, whereas in a complex deployment there can be tens, hundreds, or even more statements, each fetching a distinct type of data.

If the size of a particular enterprise, the size of an associated operational datastore and the frequency of update activity are growing, then the disadvantages described above can become more serious as time passes. For example, performance of a deployment process can cause enough delay as to impact operational efficiency of the enterprise due to delays between operational datastore changes and deployment of those changes to external machines and systems. During the delay, the machines and systems can operate at less than peak efficiency.

Thus, needs exist for improved techniques of building a deployment process to fetch selective data from an authoritative, operational and dynamic relational datastore needed by the deployment process.

### SUMMARY

Provided herein are embodiments of systems and methods of building a deployment process to fetch selective data from an authoritative, operational and dynamic (frequently updated) relational datastore needed by the deployment process. The systems can include a processing computation for a single query statement, a process for transforming and decorating the deployment output data and a transfer process for conveying the data to one or more target deployment devices or systems. The methods can include deriving a single, optimized Structured Query Language (SQL) statement that uses a read committed isolation level provided by many relational databases from the output specification and the structure of data in the datastore. Additionally, the method can include testing the single SQL statement by executing the statement on an operational datastore that stores an arbitrarily large data set from which data is selected, applying at least one transformation rule used to decorate and format an output to be deployed and transferring the decorated data to a target device or system. Also, the method can include verifying and optimizing the deployment process by iteration. A computer program product such as a program stored in non-transitory computer readable memory and executable by a process can allow a user to iteratively develop, test and optimize a single SQL statement.

Other systems, devices, methods, features and advantages of the subject matter described herein will be or will become apparent to one with skill in the art upon examination of the following figures and detailed description. It is intended that all such additional systems, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is a network hierarchy showing an example embodiment including subnets which in turn contain pools and static addresses.

FIG. 2 shows an example embodiment of a database table representing a network containing subnets.

FIG. 3 shows an example embodiment of a database table of the address pools in a network.

FIG. 4 shows an example embodiment of a database of static addresses (hosts) in a network.

FIG. 5 shows an example embodiment of a database table of locations of subnets.

FIG. 6 shows an example embodiment of user inputs to select clauses for a network.

FIG. 7 shows an example embodiment of a column schema for the output of a single SQL statement.

FIG. 8 shows an example embodiment of the output specification for a network deployment.

FIG. 9 shows an example embodiment of a user interface of a deployment editor for an example network.

FIG. 10 shows an example embodiment of system components for a deployment tool and a deployment process.

FIG. 11 shows an example embodiment of a flowchart of logic of a deployment tool.

FIG. 12 shows hardware components of the preferred embodiment.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Provided herein are systems and methods for retrieving consistent data from a very large data store by means of a single SQL statement that uses a read committed isolation level.

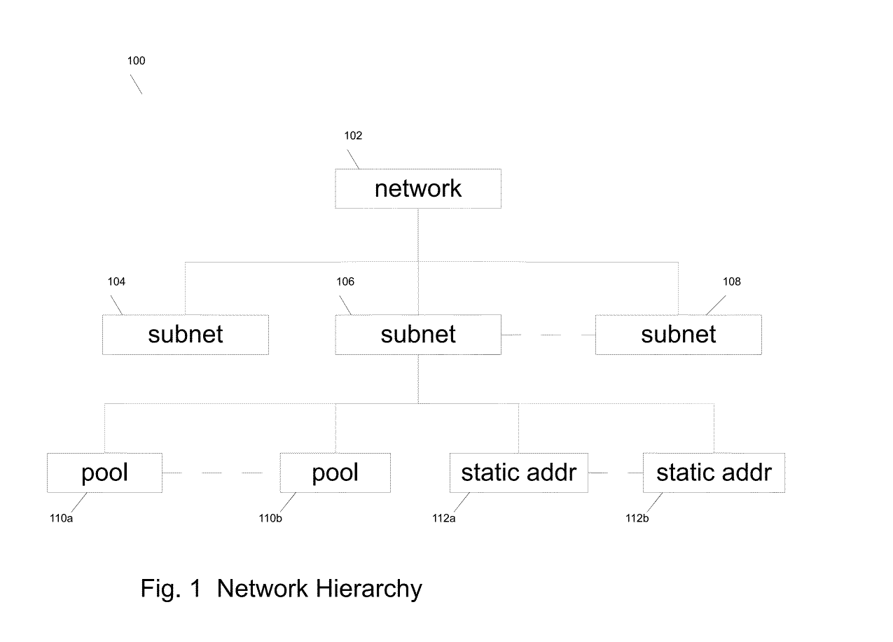

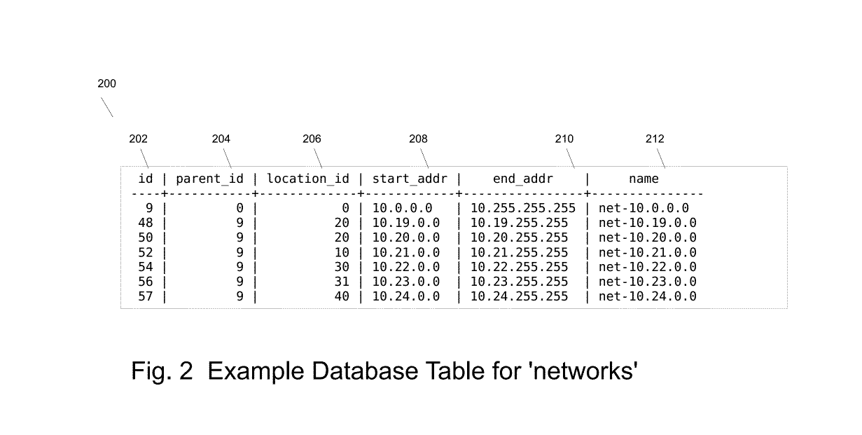

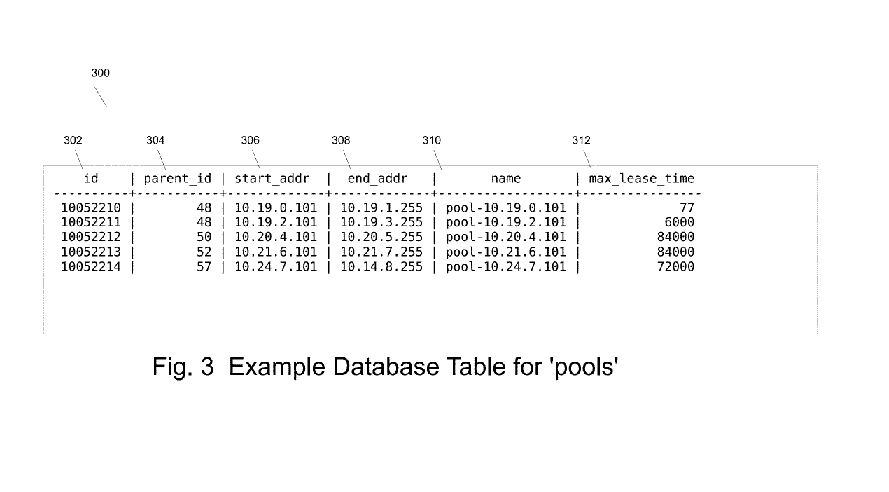

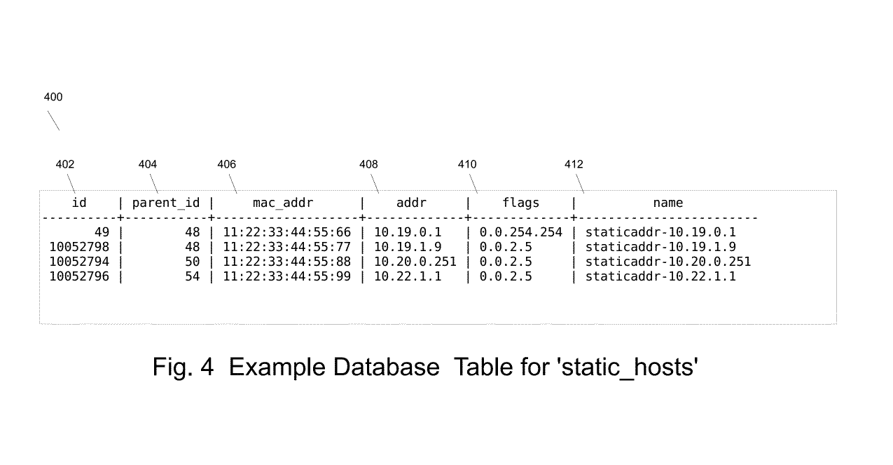

The preferred embodiment of this invention can be demonstrated using the example of DHCP network data deployment. FIG. 1 is a network hierarchy 100 showing an example embodiment including subnets 104, 106, 108 that in turn can contain pools 110a, 110b and static addresses 112a, 112b. FIGS. 2, 3, and 4 show examples of database tables illustrating parts of the network hierarchy shown in FIG. 1. In FIG. 2 an example database table 200 for ‘networks,’ shows that networks and subnets, which are networks within networks, can each comprise an identifier 202, a parent network (if present) 204, a location identifier 206, a network start IP address 208, a network end IP address 210 and a network name 212. In FIG. 3, an example database table 300 for ‘pools’ shows that each pool of IP addresses for dynamic address allocation by a DHCP server may include an identifier 302, a parent network reference identifier 304, a pool start address 306, a pool end address 308 and other attributes such as name 310 and maximum lease time 312. In FIG. 4, example database table 400 for ‘static_hosts’ shows that each static IP addresses for hosts may include an identifier 402, a parent network reference identifier 404, a host media access control (MAC) address 406, a host IP address 408 and other attributes such as flags 410 and host name 412.

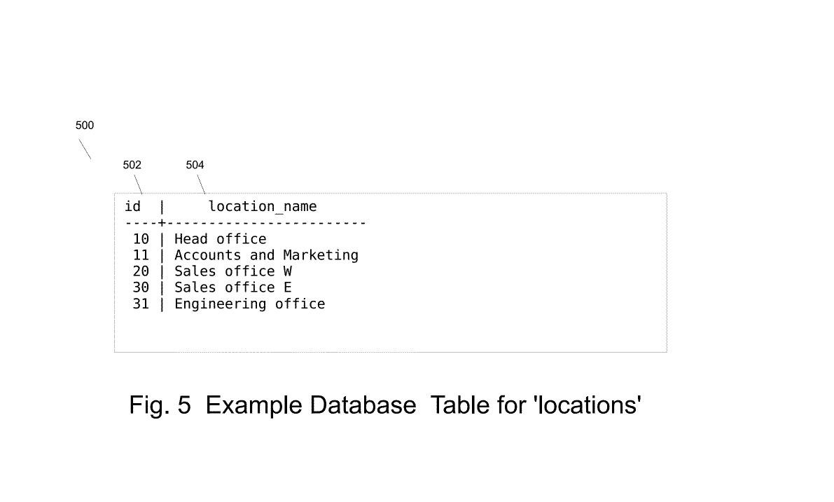

FIG. 5 shows an example embodiment of a database table 500 of contextual information of the organization for which the deployment is being done, in this case locations. Each location may include an identifier 502 and a location name 504.

In an embodiment of this invention an operational datastore can be a database that is a source of a plurality of N deployment data sets. While in practice the number of deployment data sets can be arbitrarily large, a value of N is 3 will be used as a non-limiting example herein.

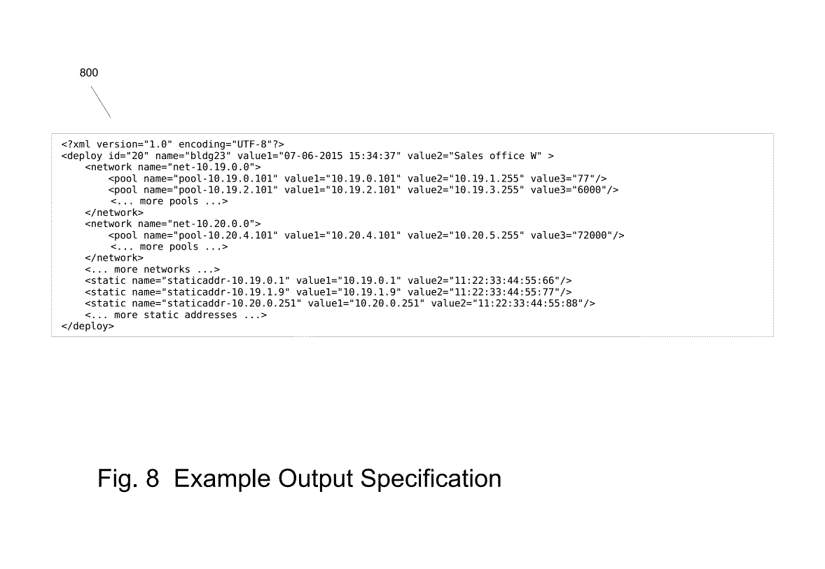

The method of this invention includes one or more iterations of generating, on a computer operably connected to the operational datastore, a single, composite SQL statement to satisfy a desired, preset output specification as determined by a target service or agent; the output specification can be defined by at least one of semantic content, syntax, and order of items in the output to be generated. As an example, if an output is a DHCP configuration then semantic content can be network information to which the DHCP configuration applies. Syntax and order of appearance can be defined by the DHCP target service, as illustrated in FIG. 8. To elaborate, FIG. 8 shows an example embodiment of the output specification 800 for a network deployment.

In a first iteration, a series of steps can occur including:

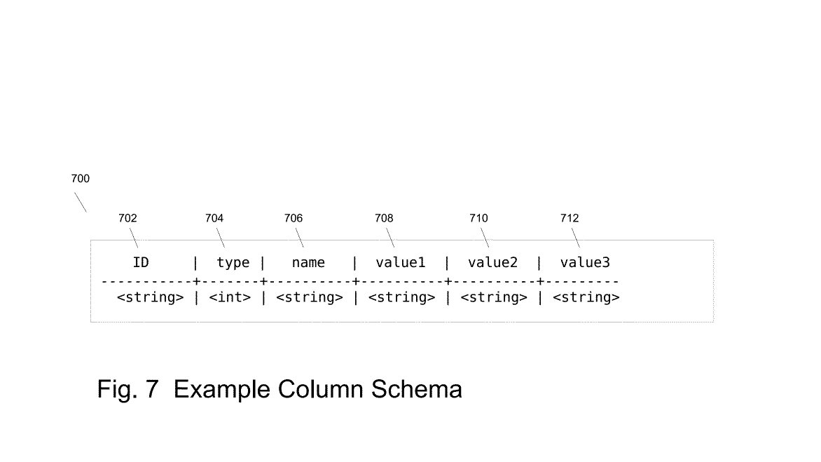

From the output specification identifying an answer set for generation by Select clauses and an estimation of a feasible order for the answer set, which can be a non-optimized order. Each select clause can be constructed to define homogenous tuples (i.e. sets of values) to appear in an answer set row, where all tuples in each answer set row have an identical schema of column names and column definitions, even though data represented by the tuples in a row can be different from data in each other row. An example of a column schema can have dimensions of d=6 columns, representing elements of at least one data type. To illustrate, FIG. 7 shows an example embodiment of a column schema 700 for the output of a single SQL statement meaningful to the deployment target. In the example embodiment a first column 702 may be an ID column, a second column 704 may be a type column and a third column 706 may be a name column. Columns not explicitly named, such as a fourth, fifth and sixth column may be labelled ‘value1’ 708, ‘value2’ 709, ‘value3’ 712 and so on.

Where N sets of tuples are deployed, the Select clauses can be represented by a set {Sᵢ} [i=1 . . . N], referencing fields from a set of tables {Tᵢ} according to a set of conditions {Cᵢ}. Within each set Sᵢ an output tuple tᵢ of dimension d can include values according to the column schema, such as integers or strings, or computation statements resulting in such values, for example a difference of 2 integers or a concatenation of 2 strings.

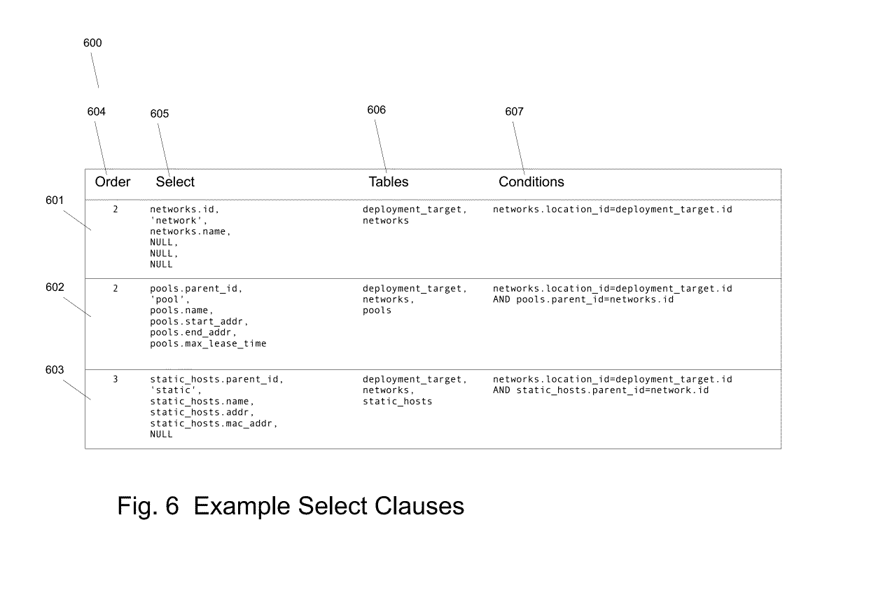

From a desired answer set {Aᵢ} [i=1 . . . N] of tuples aᵢ, of dimension d+1 where, for each i, ordering parameter zᵢ can be an integer from the set of integers [1 . . . N] and the tuple aᵢ=zᵢ U tᵢ selected from tables {Tᵢ} with conditions {Cᵢ} derive a single, composite SQL statement. FIG. 6 shows an example embodiment of select clauses 600 for a network where the number of select clauses (rows) N=3.

A first select clause S₁ 601 can be designed to extract for deployment all networks associated with the target service location from the database table ‘networks’ shown in FIG. 2 and may contain a tuple defined by: S₁={networks.id, ‘network’, networks.name} in ‘Select’ column 605, T₁={deployment_target, networks} in ‘Tables’ column 606, C₁={networklocation_id=deployment_target.id} in ‘Conditions’ column 607. Ordering parameter zᵢ can be defined in ‘Order’ column 604. A network and subnet identifier can be either, and the distinction may be purely formal in representing the network hierarchy. As such, it does not need to have any significance in the database.
A second Select clause S₂ 602 can be designed to extract DHCP pools for deployment from the database table ‘pools’ shown in FIG. 3 that are children of the networks associated with the target service location. S₂ 602 may contain a tuple defined by: S₂={pools.parent_id, ‘pool’, pools.name, pools.start_address, pools.end_address, pools.max_lease_time}, T₂={deployment_target, networks, pools}, C₂={networkslocation_id=deployment_target.id AND pools.parent_id=networks.id}. Ordering parameter zᵢ can be defined in ‘Order’ column 604 and may have the same value as the ordering parameter of a previous select clause.
A third Select clause S₃ 603 can be designed to extract static addresses for deployment from the database table ‘static_addr’ shown in FIG. 4 that are children of the networks associated with the target service location. S₃ 603 may contain a tuple defined by: S₃={static_hosts.parent_id, ‘static’, static_hosts.name, static_hosts.addr, static_hosts.mac_addr}, T₃={deployment_target, networks, static_hosts}, C₃={networks.location_id=deployment_target.id AND static_hosts.parent_id=network.id}. Ordering parameter zᵢ can be defined in ‘Order’ column 604 and may have a different value from the ordering parameter of previous select clauses.

Add the ordering parameters zᵢ to form the answer-set tuples: A₁={z₁, id, ‘network’, name, <null_string>, <null_string>, <null_string>}, A₂={z₂, id, ‘pool’, name, start_address, end_address, max_lease_time}, A₃={z₃, id, ‘static’, name, addr, mac_addr, <null_string>}. Note that <null> constants must be inserted to keep the column names and meanings consistent.

Derive a single, composite SQL statement from the answer-set tuples {Aᵢ} by generating a SQL statement for each Aᵢ using values {Sᵢ} selected from tables {Tᵢ} with conditions {Cᵢ} and performing the UNION of the resulting clauses and ordering the output first by the order parameter zᵢ in column 1 and then by the other columns as may be specified by the user. This is made possible because all elements of the answer set {Ai} conform to the same output schema 700 shown in FIG. 7.

Following the derivation of the single SQL statement, test the statement by executing it on a computer that has access to the said database to determine at least the following results: time taken to produce the output content; output content as generated by the database; transformation or decoration of the output content to generate the deployment data format desired by use in the deployment, which may include transforming the data into a data structure, for example XML, or a set of executable statements to be executed by the recipient, or both; and deployment procedure needed to invoke the single SQL statement, process the output content into the deployment format and transfer the resulting deployment data to the desired deployment destination.

These results are used to verify correctness and to decide which ordering parameters, if any, to change to optimize deployment elapsed time.

In the second iteration perform the following steps; verify that the output content contains the values needed to satisfy the deployment. From this output the format transformation used in the final stage of deployment may be applied. In the example of the preferred embodiment the output may be similar to FIG. 8. In complicated environments, verification may require completing the deployment to the end destination target service or an external validation target service, as it may not be feasible to determine correctness of the output by inspection due to subtle variations in the output that may be missed by inspection, for example; two items may be presented in an order that violates some rule imposed by the deployment target. In an example embodiment such as the DHCP context, where a list of Internet Protocol addresses representing servers is specified, the deployment target may require servers to be listed in order of preference, that is, a preferred server must be listed before an alternate server. An incorrect order of servers in a list will not be easily noticed by a human but will be discovered after actual deployment when a network client would be using an incorrect server.

The service being deployed, e.g. the DHCP service, factory shop-floor, etc., may have its own capability of verifying whether the deployment presented to it is valid or not whereby this verification capability may not be accessible other than by means of the end destination service or an external validation process.

For example, the ISC DHCP service provides a command for verifying a candidate DHCP configuration. Although a deployment analyst may detect obvious errors, the target being deployed is the final arbiter of correctness. If this verification fails, then the single SQL statement may be revised and the test re-executed until the desired result is achieved.

Once functional correctness has been verified, modify the order parameter in the first, numeric column of the answer-set tuples to rearrange the order of the Select clause result in the output content. Modify the order of the tuples in the answer set (i.e. the column positions) to control the order of the output within each Select clause result to optimize the operation of the SQL statement. On each reordering a new unique SQL statement may be derived, the test may be re-executed and the verification undertaken, wherein upon successful verification, the time taken to produce the output may be monitored. Repeat this until a satisfactory output is achieved in a satisfactory time, whereby satisfactory time may be less than a predetermined threshold, for example as determined by a service level agreement.

In the third iteration it can be possible to optimize the SQL syntax to improve performance even further by performing the following steps: examine the set of select clauses {Sᵢ}, conditions {Cᵢ} and tables {Tᵢ} and determine if there are repeated elements that are common to two or more clauses; create SQL common table expressions (CTE), for example WITH statements, that may be inserted at the front of the single SQL statement; revise and optimize the individual select clauses {Sᵢ}, conditions {Cᵢ} and tables {Tᵢ} to use the CTE.

For example a known technique involving use of a recursive CTE called “winners” may be used as follows: a first WITH clause may recursively descend the hierarchy from the Network item, selecting all those network objects of type Subnet which either are directly associated with a tag such as “EUROPE” or are descendants of those objects are directly associated with a tag such as “EUROPE;” a second WITH clause may group the results of the first WITH clause; a third WITH clause may filter results of the first WITH clause based on the groupings produced by the second WITH clause to determine the values to be deployed (i.e. the “winners”).

For a large hierarchical data set this leads to a significant reduction in processing time compared to repetitively evaluating the results to determine the “winners” and also allows the database to perform an operation in the single SQL statement that may be more time-consuming for the deployment process if performed external to the database.

After the optimization, the test may be re-executed and the verification undertaken, wherein upon successful verification, the time taken to produce the output may be monitored and used in later optimization. Repeat this revision until a satisfactory time is achieved. Note that the example shown above is comparatively simple, and a more comprehensive deployment may comprise many more Select clauses resulting in a single SQL statement that may extend over multiple pages, were it to be printed out. For example, whereas the current example includes Select clauses networks, pools and static addresses, a more complete deployment may include Select clauses for, but not limited to; device identifications, device options, configuration, configuration options, subnets, subnet options, pools, pool options, static addresses, static address options and others. Such a statement cannot ordinarily be developed and optimized on an ad hoc basis without use of this method of developing such large SQL statements on an iterative basis.

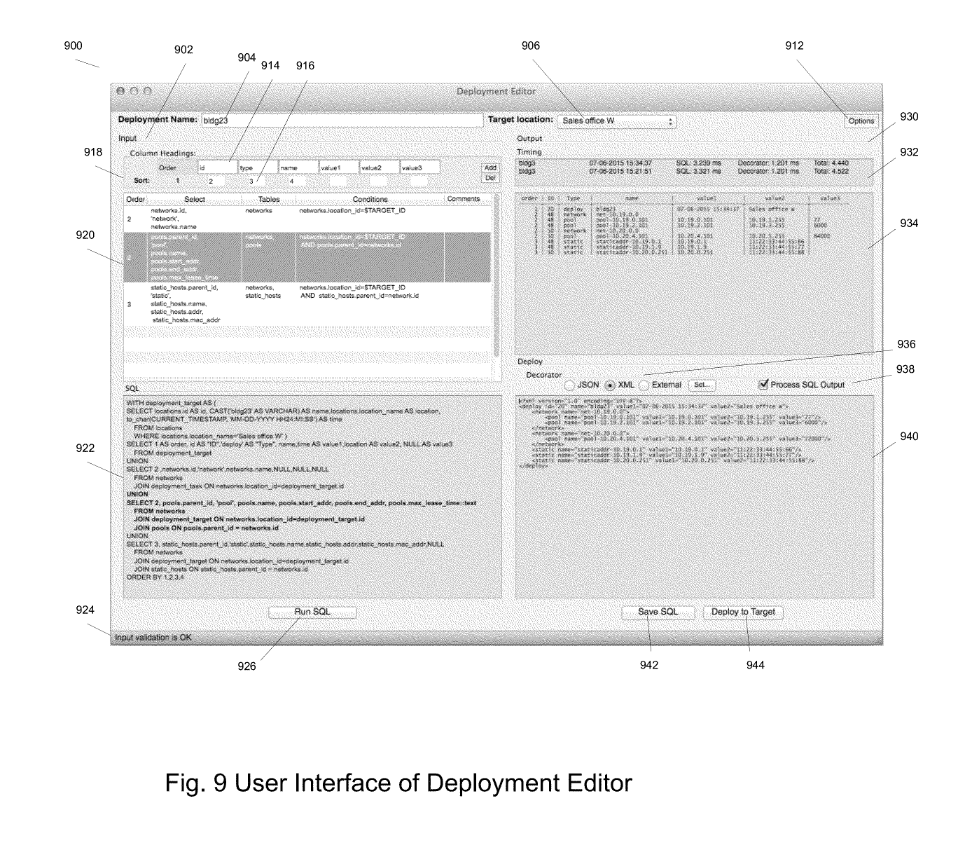

FIG. 9 shows an example embodiment of a Deployment Tool User Interface 900 where the first portion 902 is an input region for column headings 918 and sets 920 of select clauses {Si}, tables {Tᵢ}, conditions {Ci} and order set {zi}, the second portion 922 is a SQL statement display, the third portion 930 shows processing times 932 and data output 934 and the final portion 940 shows the deployed output. The tool user may also specify a name for the deployment 904 and may also select the target location of the deployment 906.

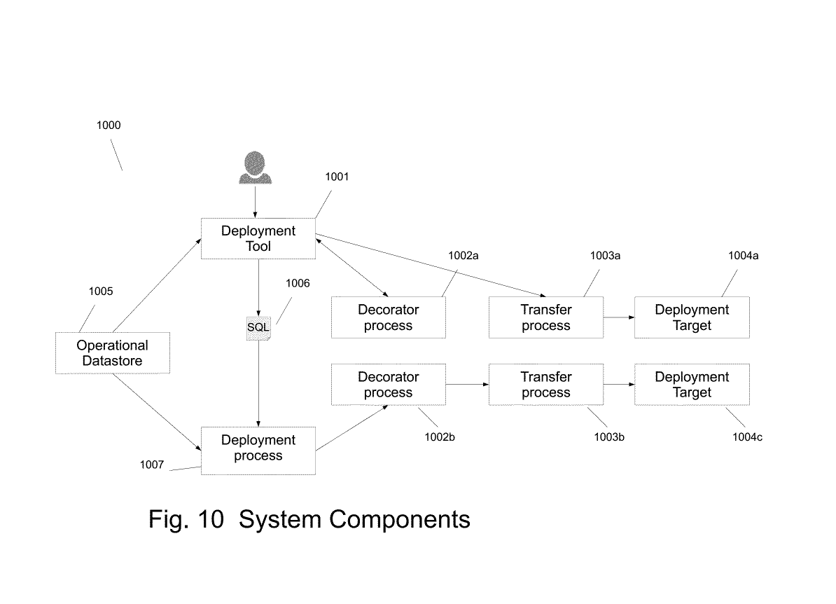

With reference to the System Components shown in FIG. 10, the preferred embodiment of this invention includes a software Deployment Tool 1001 running on a computer with a user interface 900, that interactively with the user, applies the method taught here to generate an optimum single SQL statement 922. When executed on the given database after the ‘Run SQL’ button 926 is clicked, the Deployment Tool 1001 may display the data output 934, which may be decorated by an automated process 1002a according to selection 936 that may include (but is not limited to) an XML converter, JSON format converter or customized-script decorator, producing deployment data 940 containing the format and syntax compatible with the target device or system. The tool may also include setup ‘Options’ 912, a ‘Save’ command button 942 to copy the single SQL statement and other displayed data to persistent data storage 1006 and a ‘Deploy’ command button 944 to invoke a transfer process 1003a to send the deployment data to the deployment target 1004a, where the data may be evaluated for syntactic and semantic correctness. The deployment target may be an agent locally connected to the tool or alternatively it may be connected remotely by means of a network, such as the Internet.

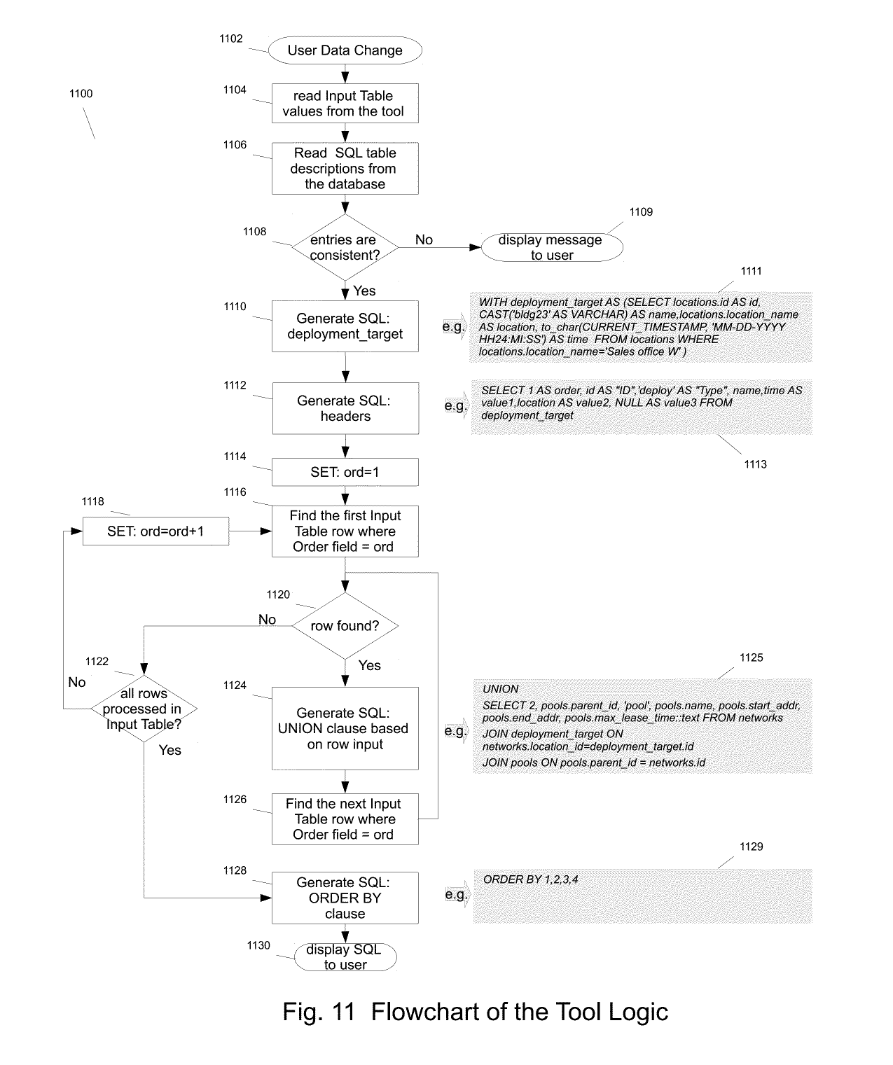

FIG. 11 shows a flowchart of the tool operation according to the method of this invention, which is invoked when user input data is changed 1102. Input data entered by the user is read 1104 by the system and database table descriptions are read 1106. If the user entries are not consistent or complete in 1108, the tool cannot process further and a message is displayed to the user 1109. Otherwise, if the input data is ok the tool can generate 1110 the deployment_target clause 1111 and the generate 1112 the header clause 1113. For example, as shown in greater detail in FIG. 11. The tool can iterate through the rows of select clauses (1116, 1118, 1120 and 1126) and generate 1124 the union clauses 1125 until all the select clauses are processed (1122). To elaborate, in 1116 the tool can find a first input table row where Order field=ord. If the row is not found the system checks to see if all rows have been processed in the input table in 1122. If not, the system sets ord to ord+1 in step 1118 and proceeds to 1116. If all rows have been processed in the table in 1122, the system generates SQL ORDER BY clause, for example ORDER BY 1, 2, 3, 4 and then proceeds to display SQL to the user on a display. If the row was found in 1120, then the system can generate a SQL UNION clause based on the row input in 1124. Next, in 1126 the system can find the next input table row where the ORDER field=ord before proceeding back to 1120. Finally, the tool can generate 1128 the Order clause 1129 and display the result 1130.

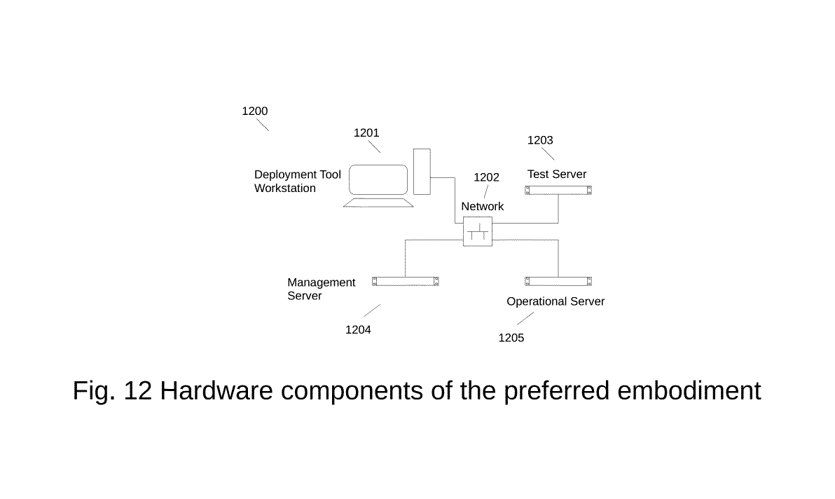

FIG. 10 shows an example embodiment of system components 1000 for a deployment tool and a deployment process. Operational datastore 1005 may be accessed by both the Deployment process 1007 and the Deployment tool 1001. Deployment tool 1001 can have access to Decorator process 1002a, Transfer process 1003a and Deployment target 1004a which may be similar to the operational Decorator process 1002b, Transfer process 1003b and Deployment target 1004c respectively but can be operating within a sandboxed or testing environment. SQL output 1006 can be transferred to the operational Deployment process 1007 when it is correct and complete. FIG. 12 is an illustration of the hardware of the preferred embodiment, wherein a Management Server 1204 may contain one or more Datastores 1005, SQL instructions 1006, Deployment Processes 1007, Decorator processes 1002b and Transfer processes 1003b (as described above with reference to FIG. 10). Management Server 1204 can be communicatively coupled with a network 1202 which can also be communicatively coupled with a deployment tool workstation 1201, a test server 1203, an operational server 1205 and other devices and components. An Operational server 1205 may contain one or more Deployment target 1004c (as described above with reference to FIG. 10). A Deployment Tool Workstation 1201 may contain one or more Deployment tools 1001, Decorator processes 1002a and Transfer processes 1003a (as described above with reference to FIG. 10). A Test server 1203 may contain one or more Deployment target 1004a. Servers described herein are known in the art and can include software hardware, processors, databases, operating systems, networking components and other necessary components. Software can include instructions stored in a tangible computer readable memory and executable by processors. Deployment tool workstation 1201 can include a user interface such as a touchscreen, keyboard, mouse, or other devices as known in the art or future developed, one or more displays, networking components, processors, software, operating systems, and other equipment.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

What is claimed is:

1. A method of deploying data from an operational database with multi-version-concurrency-control, the method comprising:
a processor executing instructions stored in a non-transitory computer memory for deriving a single SQL query statement for retrieving large amounts of related, heterogeneous data as output where the large amounts of data are internally self-consistent;
transforming and decorating the single SQL query output to obtain deployment data; and
transferring the deployment data to the deployment target.

2. The method of claim 1, further comprising: verifying the correctness of the SQL statement output and further transforming and decorating the SQL statement output based on the verification.

3. The method of claim 1, further comprising:
optimizing performance of execution of the single SQL query statement by iteratively modifying at least one of:
the order of columns in rows of data returned by the SQL statement; and
the ordering of the rows of data returned by the SQL statement.

4. The method of claim 1, where the database can be undergoing updates during the time the deployment occurs.

5. The method of claim 1, wherein deriving a single SQL statement further comprises:
determining an output specification of a SQL Select set using a processor executing computer readable instructions stored in a non-transitory computer readable medium, the SQL Select set comprising:
at least one homogeneous tuple wherein all tuples in each SQL Select set have an identical schema of column names and column meanings; and
an ordering parameter per tuple;
performing a UNION of the tuples; and
ordering an output specification first by an order parameter in a first column and then by other columns.

6. A computer-based system for deploying data comprising:
an operational database with Multi-Version-Concurrency-Control stored on at least one server;
a tool for deriving a single SQL query statement for retrieving large amounts of related, heterogeneous data where the large amounts of data are internally self-consistent;
a process for executing the single SQL query statement for retrieving large amounts of related, heterogeneous data as output;
a process for transforming and decorating the single SQL query output to obtain deployment data; and
a process for transferring the deployment data to the deployment target.

7. A computer program product for iteratively deriving a single SQL query statement for retrieving large amounts of related, heterogeneous data from an operational database with Multi-Version-Concurrency-Control where the large amounts of data are internally self-consistent, the tool comprising:
computer readable instructions stored on a non-transitory computer readable memory and executable by a processor, comprising:
a user interface for inputting and editing sets of select clauses, tables, conditions and ordering;
compiling a single SQL statement;
querying the operational database;
displaying the database output on a visual medium;
translating the database output;
displaying the translated output on a visual medium;
storing the single SQL statement to a non-transitory computer readable medium.

8. The computer program product of claim 7, further comprising transferring the translated output to a deployment target.
